(19) United States
(12) Patent Application Publication
(10) Pub. No.: US 2014/0170404 A1
(43) Pub. Date: Jun. 19, 2014

(54) LAMINATE FILM

(71) Applicant: Ching-Fu WANG, Taichung City (TW)

(72) Inventor: Ching-Fu WANG, Taichung City (TW)

(21) Appl. No.: 13/928,697

(22) Filed: Jun. 27, 2013

(30) Foreign Application Priority Data
Dec. 17, 2012 (TW) 101147798

(51) Int. Cl. B32B 27/36; B32B 7/12; G06F 1/16; B32B 27/30

(52) U.S. Cl. CPC B32B 27/36; B32B 27/304; B32B 7/12; G06F 1/1637
USPC 428/220; 428/483; 428/519; 428/336

(57) ABSTRACT

A laminate film includes an adhesive layer, an impact dispersion layer that is disposed on the adhesive layer and that is made of a composition which includes a styrene-butadiene block copolymer having styrene repeating units and butadiene repeating units, and a substrate layer that is laminated with the impact dispersion layer and composed of one of polyethylene terephthalate and polyvinylchloride.

### CROSS-REFERENCE TO RELATED APPLICATION

This application claims priority of Taiwanese Patent Application No. 101147798, filed on Dec. 17, 2012.

### BACKGROUND OF THE INVENTION

1. Field of the Invention

This invention relates to a laminate film, more particularly to a laminate film for protecting a glass surface.

2. Description of the Related Art

The enormous growing market of electronic products with touch panels or screens has resulted in a rapidly increase in demand for glass cover lens. A laminate film can be employed to be affixed on a glass surface of a mobile device in order to prevent scratches, or abrasion from dusts and particles. As disclosed in US Patent Application Publication No. US 2011/0236629, a conventional laminate film adapted for protecting a glass surface includes first and second layers for preventing scratches on the glass surface, each of which is composed of one of urethane, thermoplastic elastomer, polyether urethane, polyester urethane, and aliphatic urethane and has a Shore hardness between 25A and 25D, an elongation rate that is greater than 400% and a tensile strength that is greater than 9000 psi.

Referring to FIG. 1, another conventional laminate film 100 for protecting a transparent surface 102 from scratching is disclosed in U.S. Pat. No. 8,172,300 and includes an adhesive layer 108, a substrate 106, and a scratch resistance coating 104. The substrate 106 is substantially composed of a polyester material or a polycarbonate material, such as polyethylene terephthalate and polyvinyl chloride with plasticizer. The adhesive layer 108 is acrylic resin, and the scratch resistance coating 104 includes a mixture that is composed of at least one of acrylic monomers and colloidal silica. The substrate 106 is not only capable of maintaining the structure of the laminate film 100 but also improving the impact resistance thereof to prevent the transparent surface 102 (such as a windshield of a car) from breaking due to the impact of small particles such as rocks or debris.

There is a continuing need in the art to provide a laminate film having superior impact dispersion property while maintaining the optical property as well as the scratch protection property thereof.

### SUMMARY OF THE INVENTION

Therefore, the object of the present invention is to provide a laminate film that has superior impact dispersion property while maintaining the optical property of an underlying surface, as well as the scratch protection property thereof.

According to this invention, a laminate film includes:

an adhesive layer;

an impact dispersion layer disposed on the adhesive layer and made of a composition including a styrene-butadiene block copolymer having styrene repeating units and butadiene repeating units; and

a substrate layer laminated with the impact dispersion layer and composed of polyethylene terephthalate or polyvinylchloride.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic diagram of a conventional laminate film;

FIG. 2 is a schematic diagram of the preferred embodiment of a laminate film according to the present invention;

FIG. 3 is a schematic diagram of a modified preferred embodiment of the laminate film; and

FIG. 4 is a schematic diagram illustrating an impact testing with the preferred embodiment of the laminate film according to the present invention.

### DETAILED DESCRIPTION OF THE PREFERRED EMBODIMENT

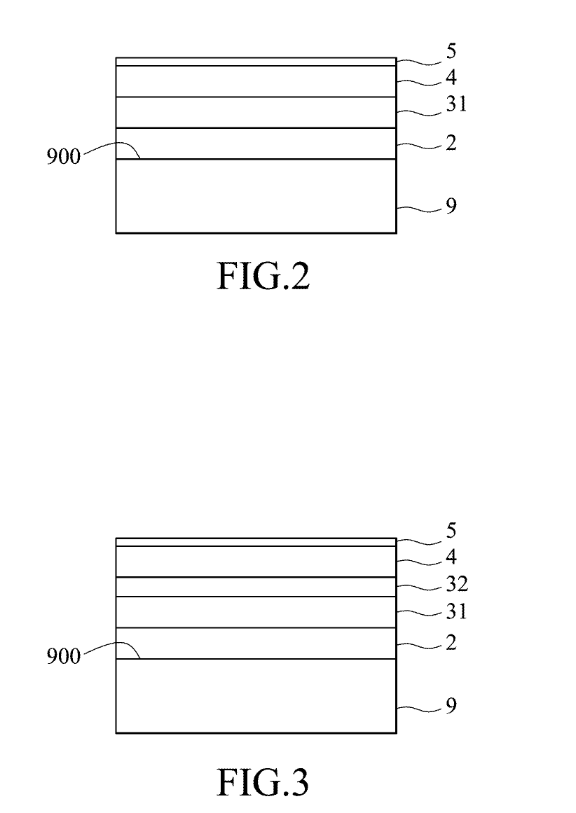

Referring to FIG. 2, the preferred embodiment of a laminate film for protecting a glass 9 according to the present invention is disclosed to include an adhesive layer 2, an impact dispersion layer 31, and a substrate layer 4.

The adhesive layer 2 is adapted for affixing on a surface 900 of the glass 9. Preferably, the adhesive layer 2 is composed of silicone or acrylic pressure-sensitive adhesives. In examples of this invention, the adhesive layer 2 is made of silicone.

The impact dispersion layer 31 is disposed on the adhesive layer 2 and is made of a composition including a styrene-butadiene block copolymer (SBC) that has good impact dispersion property, that is capable of absorbing and dispersing the impact energy, and that has styrene repeating units and butadiene repeating units. Preferably, the weight of the styrene-butadiene block copolymer ranges from 55 wt % to 70 wt % based on the total weight of the impact dispersion layer 31. Preferably, the weight percentage of the styrene repeating units ranges from 10 wt % to 90 wt % based on the total weight of the styrene-butadiene block copolymer of the impact dispersion layer 31. More preferably, the weight percentage of the styrene repeating units ranges from 70 wt % to 90 wt % based on the total weight of the styrene-butadiene block copolymer.

In this embodiment, the styrene-butadiene block copolymer of the impact dispersion layer 31 may further include ethylene repeating units and/or propylene repeating units that are obtained by partially hydrogenating the butadiene repeating units (i.e., the styrene-butadiene block copolymer of the impact dispersion layer 31 may further include styrene-ethylene/butylene-styrene (SEBS) segments and/or styrene-ethylene/propylene-styrene (SEPS) segments). Preferably, the weight percentage of the styrene repeating units ranges from 10 wt % to 40 wt % based on the total weight of the styrene-butadiene block copolymer when the styrene-butadiene block copolymer of the impact dispersion layer 31 includes the ethylene and/or propylene repeating units.

In one embodiment, the styrene-butadiene block copolymer of the impact dispersion layer 31 may be in blend with a component that is selected from the group consisting of polypropylene (PP), polyurethane (PU) polyethylene (PE), methyl methacrylate, butyl acrylate, polycarbonate (PC), ethylene vinyl acetate (EVA), and combinations thereof, so as to form a styrene-butadiene block based blend. More preferably, the weight percentage of the styrene-butadiene block copolymer is larger than 60 wt % based on the total weight of the styrene-butadiene block based blend.

Preferably, the impact dispersion layer 31 further includes a crosslinking agent, an anti-electrostatic agent, and a coloring agent. More preferably, the total weight percentage of the crosslinking agent, the anti-electrostatic agent, and the coloring agent is not greater than 5 wt % based on the total weight of the composition of the impact dispersion layer 31. In an example of this invention, the crosslinking agent is vinylsilane, the anti-electrostatic agent is Cocamidopropyl betaine, and the coloring agent is Liquidtint®. Preferably, the impact dispersion layer 31 has a thickness ranging from 30 μm to 350 μm. Preferably, the impact dispersion layer 31 has a shore hardness ranging from A20 to D42, a tensile strength ranging from 2 mPa to 120 mPa, an elongation rate ranging from 450% to 880%, a visible light transmission ranging from 80% to 99%, and a haze value that is less than 3% as measured in accordance with ASTM Standard D1003-92.

The substrate layer 4 is laminated with the impact dispersion layer 31 and is composed of polyethylene terephthalate or polyvinylchloride. More preferably, the substrate layer 4 is composed of biaxially-oriented polyethylene terephthalate. The substrate layer 4 has good toughness and wearing property so as to maintain the structure integrity of the laminate film, as well as to provide better protection for the impact dispersion layer 3.

Preferably, the laminate film further includes a scratch resistance coating 5 disposed on top of the substrate layer 4 and composed of colloidal silica or acrylic monomer. The scratch resistance coating 5 not only enhances the wearing property of the laminate film, but prevents dusts from adhering onto the laminate film.

Referring to FIG. 3, the laminate film of the present invention may further include a polymer adhesive layer 32 that is laminated between the substrate layer 4 and the impact dispersion layer 31 and that is composed of an acrylate based polymer. Preferably, the polymer adhesive layer 32 is an optical clear adhesive having a visible light transmission rate that is greater than 99%, and a haze value that is less than 2% as measured in accordance with ASTM Standard D1003-92. More preferably, the polymer adhesive layer 32 has a thickness ranging from 10 μm to 200 μm.

Preferably, the laminate film has a thickness ranging from 50 μm to 550 μm, more preferably, from 180 μm to 300 μm. Preferably, the laminate film has a visible light transmission rate that is greater than 85%. More preferably, the laminate film has a visible light transmission rate that is greater than 90% and a haze value that is less than 7%.

### EXAMPLE

### Example 1

### Ex. 1

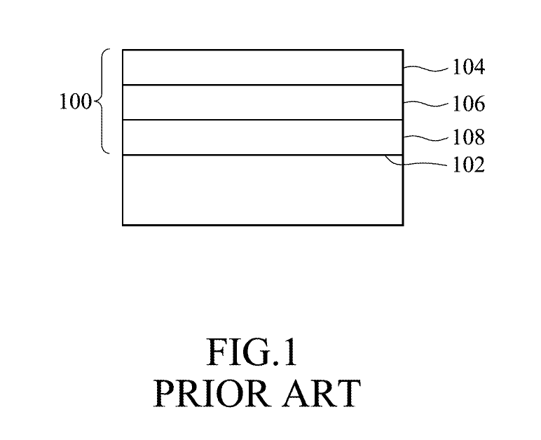

As shown in FIG. 1, the laminate film of Example 1 includes an adhesive layer 2, an impact dispersion layer 31 disposed on the adhesive layer 2, a substrate layer 4 disposed on the impact dispersion layer 31, and a scratch resistance coating 5 disposed on top of the substrate layer 4. The thickness and the composition of each layer of the laminate film of Example 1 are shown in Table 1.

### Example 2

### Ex. 2

The laminate film of Example 2 has a similar structure with that of Example 1. The difference between Examples 1 and 2 resides in that the laminate film of Example 2 further includes a polymer adhesive layer 32 that is laminated between the substrate layer 4 and the impact dispersion layer 31 and that is an optical clear adhesive which is an acrylate based polymer (e.g., 3M™ optically clear Adhesives #8171 and #8172) having a visible light transmission rate that is greater than 99% and a haze value that is less than 2%. The thickness and the composition of each layer of the laminate film of Example 2 are shown in Table 1.

TABLE 1

| Laminate film | | Example 1 | | Example 2 |
|---|---|---|---|---|
| Scratch | Composi- | Poly(methyl | | Poly(methyl |
| Resistance | tion | methacrylate) | | methacrylate) |
| Coating | Thickness | 5 | | 5 |
| | (μm) | | | |
| Substrate | Composi- | polyethylene | | polyethylene |
| layer | tion | terephthalate | | terephthalate |
| | Thickness | 145 | | 70 |
| | (μm) | | | |
| Polymer | Composi- | N/A | | Acrylate based |
| Adhesive | tion | | | polymer |
| Layer | Thickness | N/A | | 75 |
| | (μm) | | | |
| Impact | Composi- | Styrene- | 95 wt % | 95 wt % |
| dispersion | tion | butadiene | (with 70% | (with 70% |
| Layer | (100 | block | styrene | styrene |
| | wt %) | copolymer | repeating | repeating |
| | | (SBC) | units of | units of |
| | | | 100% SBC) | 100% SBC) |
| | | Anti- | <3% | <3% |
| | | electrostatic | | |
| | | agent | | |
| | | (Cocamidopropyl | | |
| | | betaine) | | |
| | | Crosslinking | <0.7% | <0.7% |
| | | agent | | |
| | | (Vinylsilane) | | |
| | | Coloring agent | <1% | <1% |
| | | (liquidtint ®) | | |

| | | | |
|---|---|---|---|
| | Thickness | 100 | 100 |
| | (μm) | | |
| Adhesive | Composi- | silicone | silicone |
| Layer | tion | | |
| | Thickness | 30 | 30 |
| | (μm) | | |

| | | |
|---|---|---|
| Bulk Thickness(μm) | 280 | 280 |

### Comparative Example 1

### CE 1

The laminate film of Comparative Example 1 is commercially available from ZAGG Inc. (Product name: invisibleSHIELD extreme).

### Comparative Example 2

### CE 2

The laminate film of Comparative Example 2 is commercially available from LLumar Company.

### Comparative Example 3

### CE 3

The laminate film of Comparative Example 3 is commercially available from Clearplex Inc.

### [Impact Testing]

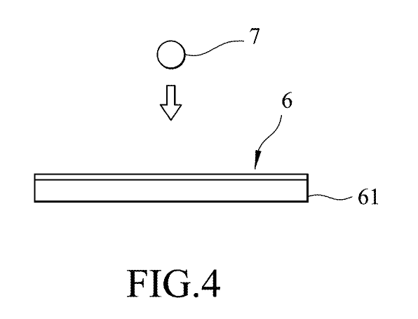

Referring to FIG. 4, the laminate film of each of the examples and comparative examples was subjected to an impact testing. Two types of the glass plate 61 were adopted for the impact testing: (a) #2947-75×25 (commercially available from Corning Inc.) with a size of 75 mm×25 mm and a thickness ranging from 0.9 mm to 1.10 mm; and (b) Gorilla (commercially available from Corning Inc.) with a size of 50 mm×50 mm and a thickness of 0.7 mm. The laminate film of each of the examples and the comparative examples was affixed to a top surface of a glass plate 61 so to form a testing sample 6. The testing sample 6 was laid on a flat ground, and a steel ball 7 was placed above the testing sample 6 with a predetermined height and dropped to impact the testing sample 6. The predetermined height was increased from 1 cm during the impact testing until the glass plate 61 of the testing sample 6 was broken by the steel ball 7. The critical impact height of each of the examples and the comparative examples where the glass plate 61 was broken was recorded and is listed in Table 2.

TABLE 2
Glass plate (a) #2947-75X25

| Steel Ball 45 g | Glass Only | Ex. 1 | Ex. 2 | CE 1 | CE 2 | CE 3 |
|---|---|---|---|---|---|---|
| Laminate film | 0 | 250 | 250 | 390 | 300 | 120 |
| Thickness(μm) | | | | | | |
| Critical impact | 4 | 35.4 | 85.58 | 22.3 | 9 | 6 |
| height(cm) | | | | | | |

Glass plate (b) Gorilla

| Steel Ball 255 g | Glass Only | Ex. 1 | Ex. 2 | CE 1 | CE 2 | CE 3 |
|---|---|---|---|---|---|---|
| Laminate film | 0 | 250 | 250 | 390 | 300 | 120 |
| Thickness(μm) | | | | | | |
| Critical Impact | 2 | 27.3 | 48 | 42 | 5 | 3 |
| Height(cm) | | | | | | |

### [Comparison Between Varied Bulk Thicknesses]

Referring to Table 2, the laminate film of Example 2 with different thickness was subjected to the impact testing, and the critical impact heights thereof are shown in Table 3.

TABLE 3

| | Example 2 | | |
|---|---|---|---|
| | 50 μm | 250 μm | 550 μm |
| Glass plate(a) | | | |
| Steel Ball(45 g) | | | |
| Critical Impact | 12 | 85.5 | 187 |
| Height(cm) | | | |
| Glass plate(b) | | | |
| Steel Ball(255 g) | | | |
| Critical Impact | 9.6 | 48 | 105.6 |
| Height(cm) | | | |

### [Comparison Between Varied Thickness of Impact Dispersion Layer and Polymer Adhesive Layer]

The laminate film of Example 2 with different thickness of the impact dispersion layer 31 and the polymer adhesive layer 32 together with the glass plate (a) was subjected to the impact testing. The critical impact heights thereof were recorded and are listed in Table 4.

TABLE 4

| Glass plate(a) | | | |
|---|---|---|---|
| Steel Ball(45 g) | Example 2 | | |
| Impact dispersion | 150 | 125 | 100 |
| layer | | | |
| Thickness(μm) | | | |
| Polymer adhesive | 50 | 75 | 100 |
| layer Thickness(μm) | | | |
| Total Thickness(μm) | 200 | 200 | 200 |
| of the impact | | | |
| dispersion layer and | | | |
| the polymer adhesive | | | |
| layer | | | |
| Critical Impact | 72.3 | 54.2 | 61.6 |
| Height(cm) | | | |

As shown in Tables 2 and 3, the glass plates with the laminate films of the examples have much better impact dispersion properties than those without the laminate films of the present invention. Further, even though the laminate films of Comparative Examples 2 and 3 are thicker than that of the examples, the laminate films of the examples still have higher corresponding critical impact heights, showing that the laminate films of the examples according to the present invention have better impact dispersion capabilities than those of the comparative examples. As shown in Table 4, the varied thicknesses of the polymer adhesion layer 32 result indifferent critical impact heights of the Example 2, showing that the polymer adhesion layer 32 not only improves bonding strength within the laminate film but is further capable of adjusting the impact dispersion property of the laminate film.

To sum up, the impact dispersion layer 31 composed of the styrene butadiene block copolymer and the polymer adhesion layer 32 in the laminate film not only improves the impact dispersion property but also maintains the transparent property of the glass.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A laminate film comprising:
an adhesive layer;
an impact dispersion layer disposed on said adhesive layer and made of a composition including a styrene-butadiene block copolymer having styrene repeating units and butadiene repeating units; and
a substrate layer laminated with said impact dispersion layer and composed of one of polyethylene terephthalate and polyvinylchloride.

2. The laminate film as claimed in claim 1, which has a visible light transmission rate not less than 85%.

3. The laminate film as claimed in claim 1, wherein the weight percentage of said styrene repeating units ranges from 10 wt % to 90 wt % based on the total weight of said styrene-butadiene block copolymer.

4. The laminate film as claimed in claim 3, wherein the weight percentage of said styrene repeating units ranges from 60 wt % to 90 wt % based on the total weight of said styrene-butadiene block copolymer.

5. The laminate film as claimed in claim 1, wherein said styrene-butadiene block copolymer further includes ethylene repeating units that are hydrogenated from said butadiene repeating units, the weight percentage of said styrene repeating units ranging from 10 wt % to 40 wt % based on the total weight of said styrene-butadiene block copolymer.

6. The laminate film as claimed in claim 5, wherein said styrene-butadiene block copolymer further includes propylene repeating units that are hydrogenated from said butadiene repeating units, the weight percentage of said styrene repeating units ranging from 10 wt % to 20 wt % based on the total weight of said styrene-butadiene block copolymer.

7. The laminate film as claimed in claim 1, wherein said composition further includes a component that is selected from the group consisting of polypropylene, polyurethane, polyethylene, methyl methacrylate, butyl acrylate, polycarbonate, ethylene vinyl acetate, and combinations thereof, said component being in blend with said styrene-butadiene block copolymer, so as to form a styrene-butadiene block based blend.

8. The laminate film as claimed in claim 7, wherein the weight percentage of said styrene-butadiene block copolymer is larger than 60 wt % based on the total weight of said styrene-butadiene block based blend.

9. The laminate film as claimed in claim 1, wherein said composition of said impact dispersion layer further includes a crosslinking agent, an anti-electrostatic agent, and a coloring agent.

10. The laminate film as claimed in claim 9, wherein the total weight percentage of said crosslinking agent, said anti-electrostatic agent, and said coloring agent is not greater than 5 wt % based on the total weight of said composition of said impact dispersion layer.

11. The laminate film as claimed in claim 1, further comprising a polymer adhesive layer that is laminated between said substrate layer and said impact dispersion layer and that is composed of an acrylic material.

12. The laminate film as claimed in claim 11, wherein said polymer adhesive layer is an optical clear adhesive having a visible light transmission rate that is greater than 99%, and a haze value that is less than 2%.

13. The laminate film as claimed in claim 11, wherein the thickness of said polymer adhesive layer ranges from 10 μm to 200 μm.

14. The laminate film as claimed in claim 1, having a thickness ranging from 50 μm to 550 μm, wherein said impact dispersion layer has a thickness ranging from 30 μm to 350 μm.

15. The laminate film as claimed in claim 1, wherein said substrate layer is disposed on top of said impact dispersion layer and is composed of biaxially-oriented polyethylene terephthalate, said laminate film further comprising a scratch resistance coating that is disposed on said substrate layer opposite to said impact dispersion layer and that is composed of one of colloidal silica and acrylic monomer.

16. The protective laminate layer as claimed in claim 1, wherein said impact dispersion layer has a Shore hardness ranging from A20 to D42, a tensile strength ranging from 2 MPa to 120 MPa, an elongation rate ranging from 450% to 880%, a visible light transmission rate ranging from 85% to 99%, and a haze value that is less than 3%.
